(19) United States
(12) Patent Application Publication
(10) Pub. No.: US 2024/0168721 A1
(43) Pub. Date: May 23, 2024

(54) APPARATUS FOR GENERATING A PLURALITY OF ULTRA-HIGH SPEED PSEUDO-RANDOM SIGNALS AND MULTICHANNEL PSEUDO-RANDOM NOISE MODULATION DEVICE THEREOF

(71) Applicant: UNIVERSITY OF ELECTRONIC SCIENCE AND TECHNOLOGY OF CHINA, Chengdu (CN)

(72) Inventors: Bo XU, Chengdu (CN); Libing Bai, Chengdu (CN); Xiaowei Luo, Chengdu (CN); Jia Zhao, Chengdu (CN); Yuhua Cheng, Chengdu (CN); Hang Geng, Chengdu (CN); Kai Chen, Chengdu (CN); Yifan Wang, Chengdu (CN); Gen Qiu, Chengdu (CN)

(73) Assignee: UNIVERSITY OF ELECTRONIC SCIENCE AND TECHNOLOGY OF CHINA, Chengdu (CN)

(21) Appl. No.: 18/403,575

(22) Filed: Jan. 3, 2024

(30) Foreign Application Priority Data
Sep. 5, 2023 (CN) 202311143904.5
Sep. 5, 2023 (CN) 202311143919.1

(51) Int. Cl. G06F 7/58

(52) U.S. Cl. CPC G06F 7/582

(57) ABSTRACT

A random transient power test signal generator based on three-dimensional memristive discrete map, which utilizes a three-dimensional parallel bi-memristor Logistic map module to generate two pseudo-random sequences, and based on the sequences, uses two waveform output modules to generate transient voltage and transient current signals respectively, thus the random transient power testing signal is obtained. The map can significantly improve the complexity of chaos and greatly extend its range of chaos. In addition, a performance evaluation shows the map has more robust hyperchaotic behavior in much larger chaos range. Moreover, the random sequences generated by the map module combines with DDS, which can generate a transient power signal with completely random period, starting phase and ending phase. Thus, a stimulated output of the high-precision transient power testing signal with random characteristic is realized, which makes the development and calibration of high-precision measurement of power meters more convenient.

### FIELD OF THE INVENTION

This application claims priorities under the Paris Convention to Chinese Patent Applications No. 202311143919.1 and 202311143904.5, both of which are filed on Sep. 5, 2023, the entirety of which is hereby incorporated by reference for all purposes as if fully set forth herein.

The present invention relates to the fields of generating pseudo-random signals and modulating multichannel signals by using the generated pseudo-random signals, more particularly to an apparatus for generating a plurality of ultra-high speed pseudo-random signals and a multichannel pseudo-random noise modulation device thereof.

### BACKGROUND OF THE INVENTION

In traditional FPGA based chaos iterative calculation module, there exist some mismatches of time delays between different equations and different calculation parts of an equation, which leads to iteration disorder. To avoid iteration disorder, a busy-free structure is adopted by the traditional FPGA based chaos iterative calculation module, i.e., the traditional FPGA based chaos iterative calculation module is set to busy state, rejecting the input of any data, until the current iteration calculation is completed. For the calculation of an equation, the result of early completed calculation part will be stored into its corresponding register, waiting the other calculation part or parts be completed. When the other calculation part or parts are completed, the result will be read out and used to calculate with the result of the other calculation part or results of the other calculation part or parts. For the different equations, the next state value of the early completed equation will be store into its corresponding register, waiting the other equation or equations be completed. When the calculations of all equations are completed, the next state values stored in registers are outputted along with the last next state value. Then the traditional FPGA based chaos iterative calculation module is set to free state, and ready for the next iteration.

The busy-free structure can avoid iteration disorder. However, the time consumption is high. If a chaos iterative calculation needs N clocks (usually hundreds of clocks are needed), then N clocks are needed to output a plurality of the next state values of a chaos model. The efficiency of chaos iterative calculation is low.

In addition, the number of outputs of the chaos iterative calculation module is limited. Taking the 3D chaos iterative calculation module as an example, it has only three outputs, namely three channels of pseudo-random signals are outputted, which can't satisfy the demand when more channels of pseudo-random signals are needed.

Meanwhile, multichannel pseudo-random noise modulation device needs a plurality of pseudo-random signals to modulate waveform signals. However, the traditional FPGA based chaos iterative calculation module can't generate more channels of pseudo-random signals, thus it can't be applied to multichannel pseudo-random noise modulation device.

### SUMMARY OF THE INVENTION

The present invention aims to overcome the deficiencies of the prior art, and provides an apparatus for generating a plurality of ultra-high speed pseudo-random signals and a multichannel pseudo-random noise modulation device thereof, so as to realize the generation of a plurality of ultra-high speed multi-bit pseudo-random signals and the uniform modulation of waveform signals of multiple channels with ultra-high pseudo-random noises.

To achieve these objectives, in accordance with the present invention, an apparatus for generating a plurality of ultra-high speed pseudo-random signals is provided, comprising:
a chaos iterative model module based on pipeline structure, which consists of a chaotic equation submodule, a parameters ROM reading submodule and a chaotic state value RAM reading and writing submodule, wherein when a time delay is needed for synchronization in each chaotic equation and between chaotic equations of the chaotic equation submodule, a shift register is adopted to buffer the early result through its shift, the number of the registers in the shift register is equal to the number of the clocks that correspond to the time delay, which makes the chaotic equation submodule can perform iterative calculation with pipelining, the parameters ROM reading submodule is used for storing m pluralities of chaotic equation parameters, the chaotic state value RAM reading and writing submodule is used for storing m pluralities of current state values, the initial values of m pluralities of current state values are from an upper computer; for each clock, a plurality of chaotic equation parameters are read out from the parameters ROM reading submodule and sent to the chaotic equation submodule, a plurality of current state values are read out from the chaotic state value RAM reading and writing submodule and sent to the chaotic equation submodule, the chaotic equation submodule performs iterative calculation by received plurality of chaotic equation parameters and plurality of current state values, and then, on the one hand, the results of the iterative calculation, namely next state values are outputted, on the other hand, taken as the current state values of next iterative calculation to update the current state values in the chaotic state value RAM reading and writing submodule, meanwhile, the chaotic equation submodule outputs a write address which is used for updating the current state values in the chaotic state value RAM reading and writing submodule, where m is greater than the number of the clocks needed in calculation of a plurality of next state values;
a m-sequence update control module, which is used for receiving the next state values and the write address outputted by the chaotic equation submodule and performing two operations: data combining: combining the next state values outputted by the chaotic equation submodule into a data, namely combined data and outputting the combined data, and sequence module selectively updating: taking the write address as a chaos number to drive a m-sequence update state machine to output an update enable signal;
a plurality of m-sequence modules, where each m-sequence module comprises multiple pairs of m-sequence generator and m-sequence feedback coefficient ROM, when a m-sequence module receives the combined data and the update enable signal, it splits the combined data into multiple pairs of m-sequence generator initial value and feedback coefficient read address, each pair of m-sequence generator initial value and feedback coefficient read address corresponds to a pair of m-sequence generator and m-sequence feedback coefficient ROM, the m-sequence module reads out a m-sequence feedback coefficient according its feedback coefficient read address, and then updates the feedback coefficient of the m-sequence generator with the m-sequence feedback coefficient and the initial value of the m-sequence generator with the m-sequence generator initial value; a m-sequence generator outputs one-bit data at every clock, the one-bit data outputted by the m-sequence generators of a m-sequence module at every clock compose one multi-bit data of a channel, the multi-bit data outputted by the plurality of m-sequence modules compose a plurality of ultra-high speed multi-bit pseudo-random signals.

In addition, a multichannel pseudo-random noise modulation device thereof is provided, comprising:
a chaos iterative model module based on pipeline structure, which consists of a chaotic equation submodule, a parameters ROM reading submodule and a chaotic state value RAM reading and writing submodule, wherein when a time delay is needed for synchronization in each chaotic equation and between chaotic equations of the chaotic equation submodule, a shift register is adopted to buffer the early result through its shift, the number of the registers in the shift register is equal to the number of the clocks that correspond to the time delay, which makes the chaotic equation submodule can perform iterative calculation with pipelining, the parameters ROM reading submodule is used for storing m pluralities of chaotic equation parameters, the chaotic state value RAM reading and writing submodule is used for storing m pluralities of current state values, the initial values of m pluralities of current state values are from an upper computer; for each clock, a plurality of chaotic equation parameters are read out from the parameters ROM reading submodule and sent to the chaotic equation submodule, a plurality of current state values are read out from the chaotic state value RAM reading and writing submodule and sent to the chaotic equation submodule, the chaotic equation submodule performs iterative calculation by received plurality of chaotic equation parameters and plurality of current state values, and then, on the one hand, the results of the iterative calculation, namely next state values are outputted, on the other hand, taken as the current state values of next iterative calculation to update the current state values in the chaotic state value RAM reading and writing submodule, meanwhile, the chaotic equation submodule outputs a write address which is used for updating the current state values in the chaotic state value RAM reading and writing submodule, where m is greater than the number of the clocks needed in calculation of a plurality of next state values;
a m-sequence update control module, which is used for receiving the next state values and the write address outputted by the chaotic equation submodule and performing two operations: data combining: combining the next state values outputted by the chaotic equation submodule into a data, namely combined data and outputting the combined data, and sequence module selectively updating: taking the write address as a chaos number to drive a m-sequence update state machine to output an update enable signal;
a plurality of m-sequence modules, where each m-sequence module comprises multiple pairs of m-sequence generator and m-sequence feedback coefficient ROM, when a m-sequence module receives the combined data and the update enable signal, it splits the combined data into multiple pairs of m-sequence generator initial value and feedback coefficient read address, each pair of m-sequence generator initial value and feedback coefficient read address corresponds to a pair of m-sequence generator and m-sequence feedback coefficient ROM, the m-sequence module reads out a m-sequence feedback coefficient according its feedback coefficient read address, and then updates the feedback coefficient of the m-sequence generator with the m-sequence feedback coefficient and the initial value of the m-sequence generator with the m-sequence generator initial value; a m-sequence generator outputs one-bit data at every clock, the one-bit data outputted by the m-sequence generators of a m-sequence module at every clock compose one multi-bit data of a channel, the multi-bit data outputted by the plurality of m-sequence modules compose a plurality of ultra-high speed multi-bit pseudo-random signals;
a DDS module, which is used for generating a plurality of arbitrary waveform signals, wherein an arbitrary waveform signal corresponds to an ultra-high speed multi-bit pseudo-random signal;
a signal modulation module, which is used for receiving the plurality of ultra-high speed multi-bit pseudo-random signals and the plurality of arbitrary waveform signals, and taking each ultra-high speed multi-bit pseudo-random signal as a noise signal to modulate its corresponding arbitrary waveform signal by additive modulation ratio k, then converting the format of the noise modulated arbitrary waveform signals into integer and outputting the modulated arbitrary waveform signals of integer, where additive modulation ratio k is sent from an upper computer;
a DAC module, which is used for converting each noise modulated arbitrary waveform signal of integer outputted by the signal modulation module into an analog signal, wherein all analog signals compose multi channels of pseudo-random noise signals.

The objectives of the present invention are realized as follows:

In accordance with the present invention, an apparatus for generating a plurality of ultra-high speed pseudo-random signals is provided, which comprises a chaos iterative model module, a m-sequence update control module and a plurality of m-sequence modules. Wherein the chaotic equation submodule in the chaos iterative model module adopts shift registers to buffer the early results, meanwhile, a parameters ROM reading submodule and a chaotic state value RAM reading and writing submodule are added in the chaos iterative model module to form a pipeline structure of iterative calculation, thus a chaotic equation can output a next state value at each clock, ultra-high speed iterative output values (next state values) are generated. In addition, the m-sequence update control module combines the next state values outputted by the chaotic equation submodule into a data, namely combined data and generates (outputs) an update enable signal according to the writing address of the next state values. When a m-sequence module receives the combined data and the update enable signal, it splits the combined data into multiple pairs of m-sequence generator initial value and feedback coefficient read address, which correspond to multiple pairs of m-sequence generator and m-sequence feedback coefficient ROM respectively. A m-sequence module reads out a m-sequence feedback coefficient according its feedback coefficient read address, and then updates the feedback coefficient of the m-sequence generator with the m-sequence feedback coefficient and the initial value of the m-sequence generator with the m-sequence generator initial value, thus a plurality of ultra-high speed multi-bit pseudo-random signals are generated. In this way, the randomness of m-sequence module can be guaranteed from the two dimensions of feedback coefficient and initial value, which guarantee the output value of m-sequence module always be random and avoid being stuck in periodic repetition. The present invention integrates chaos iterative model with m-sequence generator, which realizes the uniform generation of a plurality of ultra-high speed multi-bit pseudo-random signals. On the basis of the uniform generation of a plurality of ultra-high speed multi-bit pseudo-random signals, combined with the feature that DDS can generate arbitrary waveform signals, the arbitrary waveform signals are modulated with ultra-high speed multi-bit pseudo-random signals respectively, and the modulated arbitrary waveform signals are converted into analogy signals, so multi channels of pseudo-random noise signals are obtained, and the uniform modulation of waveform signals of multiple channels with ultra-high pseudo-random noises is realized.

### BRIEF DESCRIPTION OF THE DRAWING

The above and other objectives, features and advantages of the present invention will be more apparent from the following detailed description taken in conjunction with the accompanying drawings, in which:

FIG. 1 is a diagram of an apparatus for generating a plurality of ultra-high speed pseudo-random signals in accordance with one embodiment of the present invention;

FIG. 2(a)-FIG. 2(d) are diagrams of chaotic map phase trajectories under a plurality of chaotic equation parameters and another plurality of initial values of current state values, where FIG. 2(a) is a diagram of chaotic map phase trajectory of x-y, FIG. 2(b) is a diagram of chaotic map phase trajectory of x-z, FIG. 2(c) is a diagram of chaotic map phase trajectory of y-z, FIG. 2(d) is a diagram of chaotic map phase trajectory of x-y-z;

FIG. 3(a)-FIG. 3(d) are diagrams of chaotic map phase trajectories under another plurality of chaotic equation parameters and a plurality of initial values of current state values, where FIG. 3(a) is a diagram of chaotic map phase trajectory of x-y, FIG. 3(b) is a diagram of chaotic map phase trajectory of x-z, FIG. 3(c) is a diagram of chaotic map phase trajectory of y-z, FIG. 3(d) is a diagram of chaotic map phase trajectory of x-y-z;

FIG. 4 is a diagram of the chaos iterative model module based on pipeline structure shown in FIG. 1 in accordance with one embodiment of the present invention;

FIG. 5 is a diagram of iterative calculation with pipelining;

FIG. 6 is a control timing diagram of read address read_addr shown in FIG. 4;

FIG. 7 is a control timing diagram of write address write_addr shown in FIG. 4;

FIG. 8 is a diagram of the m-sequence update control module shown in FIG. 1 in accordance with one embodiment of the present invention;

FIG. 9 is a control timing diagram of the m-sequence update control module shown in FIG. 8;

FIG. 10 is a diagram of the m-sequence update control module shown in FIG. 1 in accordance with another embodiment of the present invention;

FIG. 11 is a control timing diagram of the m-sequence update control module shown in FIG. 10;

FIG. 12 is a diagram of a m-sequence module in accordance with one embodiment of the present invention;

FIG. 13 is a diagram of a multichannel pseudo-random noise modulation device in accordance with one embodiment of the present invention;

FIG. 14 is an oscillogram of illustrations of modulating different waveform signals in accordance with the present invention;

FIG. 15 is an oscillogram of illustrations of modulating a square waveform signal by different additive modulation ratios in accordance with the present invention.

### DETAILED DESCRIPTION OF THE PREFERRED EMBODIMENT

Hereinafter, preferred embodiments of the present invention will be described with reference to the accompanying drawings. It should be noted that the similar modules are designated by similar reference numerals although they are illustrated in different drawings. Also, in the following description, a detailed description of known functions and configurations incorporated herein will be omitted when it may obscure the subject matter of the present invention.

The main realization idea of the present invention is: firstly, the chaos iterative model module based on pipeline structure calculates the chaotic state values (next state values) of m pluralities of chaotic equation parameters in real time, then the m-sequence update control module generates a combined data by using the chaotic state values, and based on the write address outputted by the chaotic equation submodule, generates an update enable signal to drive the plurality of m-sequence modules, thus a plurality of ultra-high speed multi-bit pseudo-random signals can be generated uniformly and randomly, which can be applied to various fields, such as signal modulation.

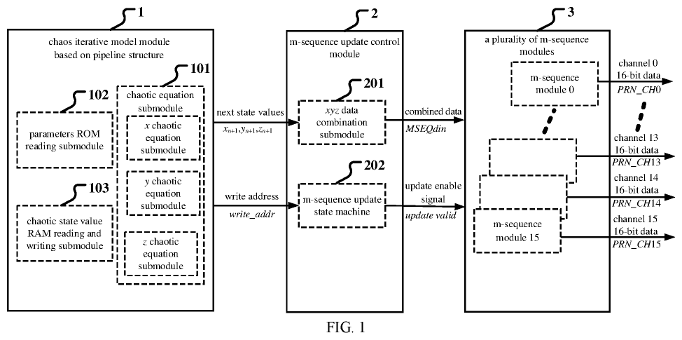

FIG. 1 is a diagram of an apparatus for generating a plurality of ultra-high speed pseudo-random signals in accordance with one embodiment of the present invention.

In the embodiment, as shown in FIG. 1, the present invention provides an apparatus for generating a plurality of ultra-high speed pseudo-random signals, which comprises a chaos iterative model module based on pipeline structure 1, a m-sequence update control module 2 and a plurality of m-sequence modules 3.

1. Chaos Iterative Model Module Based on Pipeline Structure

In the embodiment, as shown in FIG. 1, the chaos iterative model module based on pipeline structure (hereinafter referred chaos iterative model module) as consists of a chaotic equation submodule 101, a parameters ROM reading submodule 102 and a chaotic state value RAM reading and writing submodule 103.

When a time delay is needed for synchronization in each chaotic equation and between chaotic equations of the chaotic equation submodule 101, a shift register is adopted to buffer the early result through its shift, the number of the registers in the shift register is equal to the number of the clocks that correspond to the time delay, which makes the chaotic equation submodule can perform iterative calculation with pipelining.

The parameters ROM reading submodule 102 is used for storing m pluralities of chaotic equation parameters a, b, c, d and e, the chaotic state value RAM reading and writing submodule 103 is used for storing m pluralities of current state values xₙ, yₙ and zₙ. The initial values x₀, y₀ and z₀ of m pluralities of current state values xₙ, yₙ and zₙ are from an upper computer.

For each clock, a plurality of chaotic equation parameters a, b, c, d and e are read out from the parameters ROM reading submodule 102 and sent to the chaotic equation submodule 101, a plurality of current state values xₙ, yₙ and zₙ are read out from the chaotic state value RAM reading and writing submodule 103 and sent to the chaotic equation submodule 101. The chaotic equation submodule 101 performs iterative calculation by received plurality of chaotic equation parameters a, b, c, d and e and plurality of current state values xₙ, yₙ and zₙ, and then, on the one hand, the results of the iterative calculation, namely next state values xₙ₊₁, yₙ₊₁ and zₙ₊₁ are outputted, on the other hand, taken as the current state values of next iterative calculation to update the current state values xₙ, yₙ and zₙ in the chaotic state value RAM reading and writing submodule 103. Meanwhile, the chaotic equation submodule 101 outputs a write address write_addr which is used for updating the current state values in the chaotic state value RAM reading and writing submodule 103, where m is greater than the number of the clocks needed in calculation of a plurality of next state values xₙ₊₁, yₙ₊₁ and z_{n+1.}

1.1 Chaotic Equation Submodule

Through coupling one or more trigonometric function based memristors to existing chaotic mapping, bifurcation will be enhanced. As a result, a 3D (three dimensional) trigonometric function based memristor hyper-chaotic mapping is adopted in the embodiment. The mathematic model of the memristor hyper-chaotic mapping (hereinafter referred as chaotic model) comprises three chaotic equations and can be written as follows:

$$\{ \begin{matrix}{x}_{n + 1} = {ay}_{n} + c sin ( e ( {k}_{0} + {k}_{1} {𝓏}_{n} + {k}_{2} {𝓏}_{n}^{2} ) {y}_{n} ) \\ {y}_{n + 1} = {bx}_{n} + {dy}_{n} cos {𝓏}_{n} \\ {𝓏}_{n + 1} = {𝓏}_{n} + τ {y}_{n}\end{matrix}$$

where a, b, c, d are the chaotic equation parameters. In the embodiment, m is 245, namely 245 pluralities of chaotic equation parameters a, b, c, d and e are stored in the parameters ROM reading submodule 102. Parameters k₀, k₁, k₂ and r are invariant parameters, namely, the parameters k₀, k₁, k₂ and τ used in the calculation of each plurality of next state values xₙ₊₁, yₙ₊₁, and zₙ₊₁ are the same. In the embodiment, k₀=0.1, k₁=−10, k₂=0.5 and τ=1. When chaotic equation parameters a, b, c, d and e take different values, the initial values x₀, y₀ and z₀ (hereinafter referred as state initial values) of m pluralities of current state values xₙ, yₙ and zₙ also take different values.

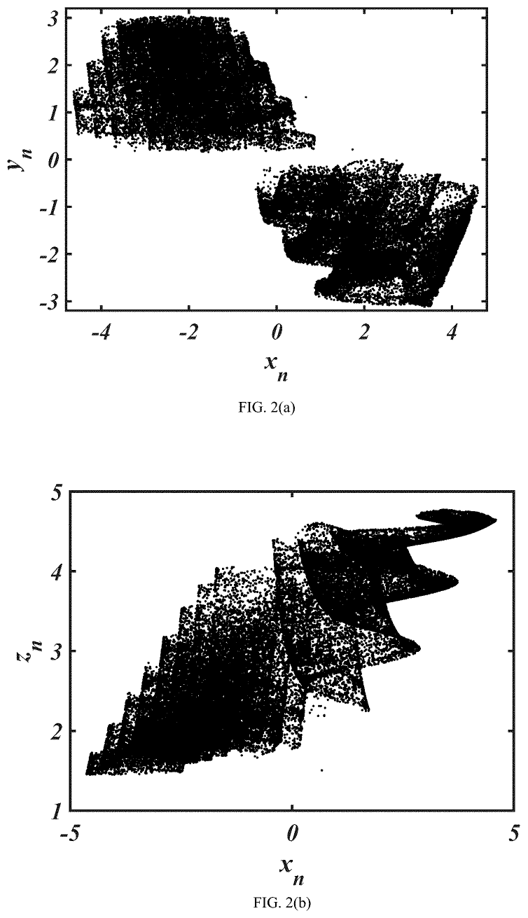

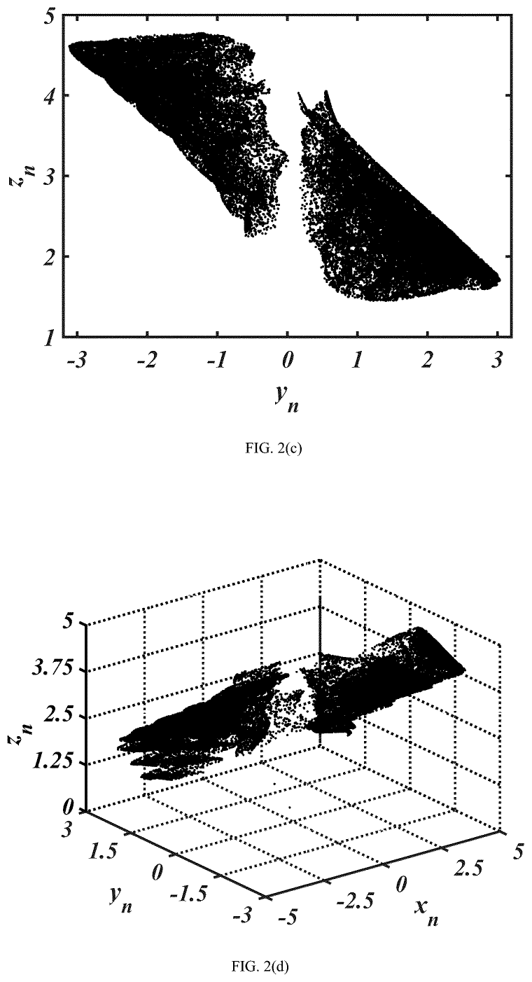

For example, when chaotic equation parameters a=1.2, b=0.1, c=−1.2, d=1.72 and e=π/6, and state initial values x₀=0.5, y₀=0.5 and z₀=0.1, the diagrams of chaotic map phase trajectories are shown in FIG. 2(a)-FIG. 2(d).

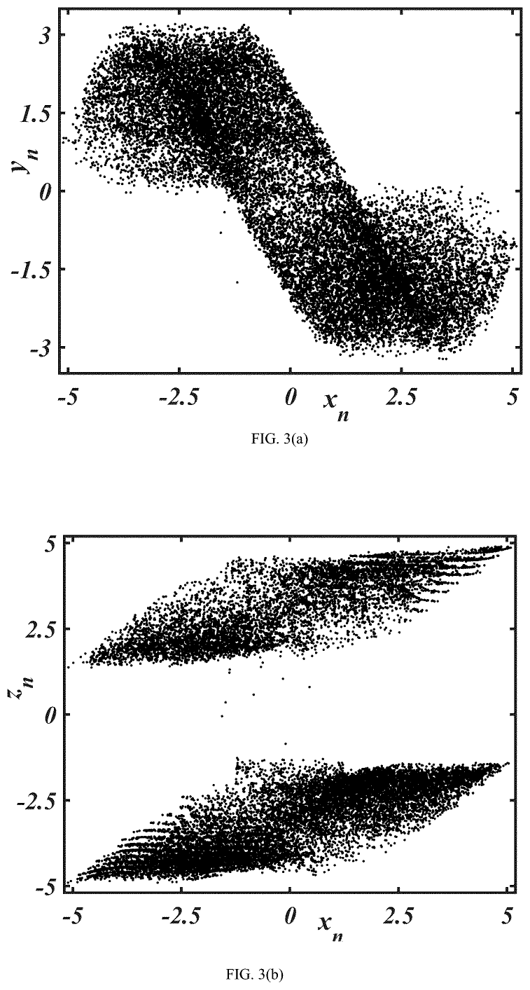

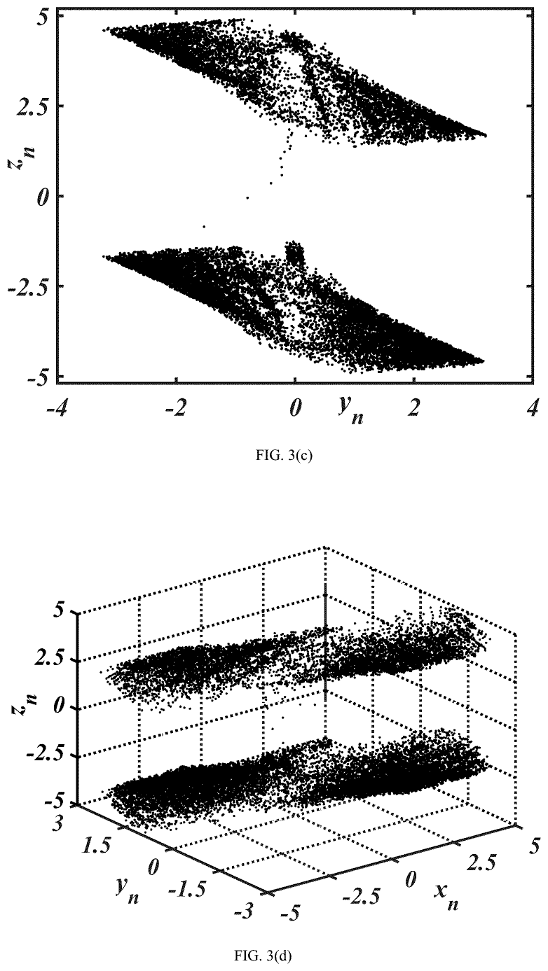

For example, when chaotic equation parameters a=1.2, b=0.1, c=−1.3, d=1.72 and e=π/2, and state initial values x₀=0.5, y₀=0.5 and z₀=0.1, the diagrams of chaotic map phase trajectories are shown in FIG. 3(a)-FIG. 3(d).

From FIG. 2(a)-FIG. 2(d) and FIG. 3(a)-FIG. 3(d), we can see that the chaotic model shows different chaotic characteristics. In the embodiment, 245 pluralities of chaotic equation parameters a, b, c, d and e are stored in the parameters ROM reading submodule 102, accordingly, 245 pluralities of state initial values x₀, y₀ and z₀ are from an upper computer and stored in the chaotic equation submodule 101.

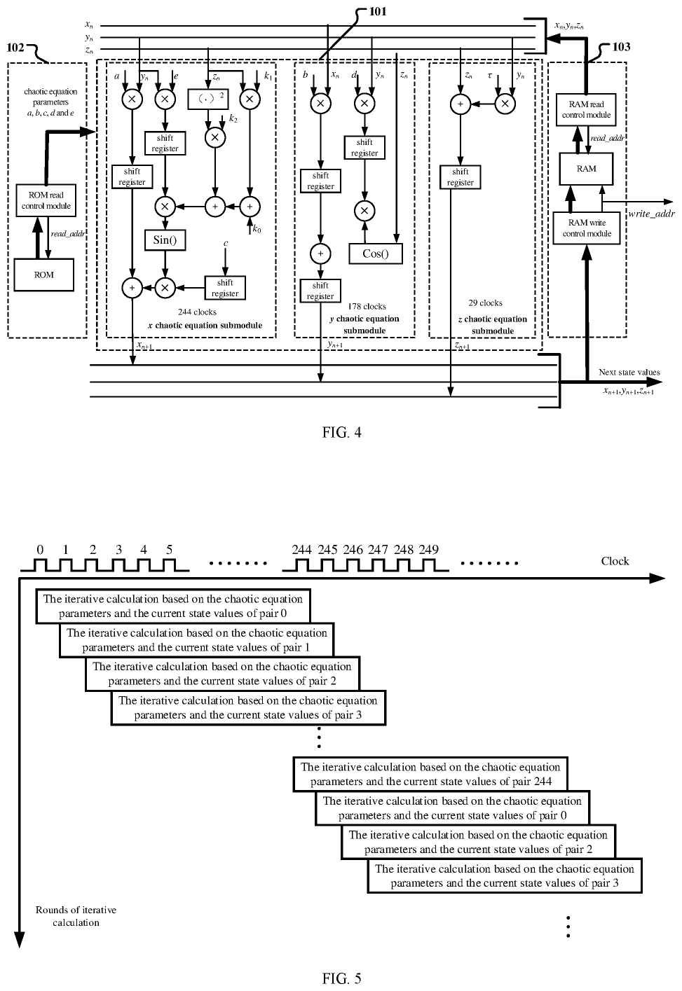

In the embodiment, the chaotic mapping is realized with pipelining in a FPGA, the diagram of the chaos iterative model module based on pipeline structure is shown in FIG. 4.

In the embodiment, as shown in FIG. 4, the chaotic equation submodule 101 comprises three chaotic equation submodules: x chaotic equation submodule, y chaotic equation submodule and z chaotic equation submodule, which are used to realize the iterative calculations of the three chaotic equations. The interior of each chaotic equation submodule is built according to corresponding equation of the chaotic mapping.

x chaotic equation submodule, y chaotic equation submodule and z chaotic equation submodule of the chaotic equation submodule 101 calculate next state values xₙ₊₁, yₙ₊₁ and zₙ₊₁ according to the chaotic equation parameters a, b, c, d and e read out from the parameters ROM reading submodule 102, the parameters k₀, k₁, k₂ and r solidified in the chaotic equation submodule 101 and the current state values xₙ, yₙ and zₙ read from the chaotic state value RAM reading and writing submodule 103. The calculated next state values xₙ₊₁, yₙ₊₁ and zₙ₊₁ taken as the current state values of next iterative calculation are written into the chaotic state value RAM reading and writing submodule 103 at corresponding address (write address), namely, update the current state values xₙ, yₙ and zₙ in the chaotic state value RAM reading and writing submodule 103.

In the embodiment, from the mathematical model of the chaotic mapping, we can see that the calculation of z dimension is the simplest, the time delay of corresponding calculation in FPGA is the shortest, only 29 clocks are needed. the calculation of x dimension is the most complex, the time delay of corresponding calculation in FPGA is the most time-consuming, 244 clocks are needed, namely, there exist some mismatches of time delays between different equations and different calculation parts of an equation, which leads to iteration disorder.

To avoid iteration disorder, a busy-free structure is adopted by the traditional FPGA based chaos iterative calculation module, i.e., the traditional FPGA based chaos iterative calculation module is set to busy state, rejecting the input of any data, until the current iteration calculation is completed. Meanwhile, the next state value (for example, the next state value zₙ₊₁ in the embodiment) of the early completed equation will be store into its corresponding register, waiting the other equation or equations be completed (for example, the calculation of the next state value xₙ₊₁ in the embodiment be completed). When the calculations of all equations are completed, the next state values (the next state value zₙ₊₁ and yₙ₊₁) stored in registers are outputted along with the last next state value (the next state value xₙ₊₁), then the traditional FPGA based chaos iterative calculation module is set to free state, and ready for the next iteration. The method mentioned above can avoid iteration disorder, however, the average time consumption is high. Taking the mathematical model of the chaotic mapping in the embodiment as example, 244 clocks are needed to output a plurality of next state values. The efficiency of chaos iterative calculation is low.

To overcome the lower efficiency of busy-free structure, the chaotic equation submodule 101 in the present invention discards the registers used for buffering the next state values and the busy state signal of rejecting the input of any data in busy-free structure. When a time delay is needed for synchronization in each chaotic equation and between chaotic equations of the chaotic equation submodule 101, a shift register will be adopted to buffer the early result through its shift, the number of the registers in the shift register is equal to the number of the clocks that correspond to the time delay, which makes the chaotic equation submodule can perform iterative calculation with pipelining.

Taking the calculation of the next state value zₙ₊₁ as example, only 29 clocks are needed in one calculation iteration of z chaotic equation, however 244 clocks are needed in one calculation iteration of x chaotic equation. To guarantee output times are the same, a shift register is adopted to buffer the next state value zₙ₊₁ through its shift, the time delay of shift register is set to 215 clocks.

In the embodiment, when the internal calculation logic in x chaotic equation submodule and y chaotic equation submodule needs time delay, the similar process can be performed. At last, the output time delays of x chaotic equation submodule, y chaotic equation submodule and z chaotic equation submodule are 244 clocks. In the embodiment, as shown in FIG. 5, for one round calculation of next state values, the chaotic equation parameters and the current state values of pair 0 is inputted at clock 0, the corresponding next state values will be obtained at clock 244, the chaotic equation parameters and the current state values of pair 1 is inputted at clock 0, the corresponding next state values will be obtained at clock 245, and so on. Thus, the calculation structure of pipelining can realize the output of a plurality of next state values at every clock, which dramatically enhances the efficiency of outputting the next state values, and fully utilizes the hardware computing units of FPGA.

In the embodiment, the initial values of the chaotic equation parameters and the current state values are 64-bit double-precision floating-point number, the calculated next state values also are 64-bit double-precision floating-point number.

1.2 Input/Output Control

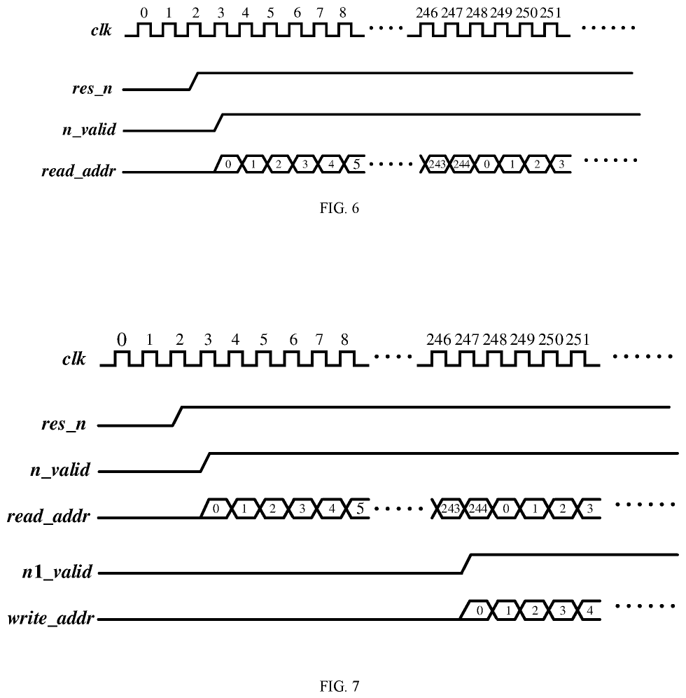

In order to realize a correct pipelining iterative calculation of the next state values, the control of reading the chaotic equation parameters and the current state values is needed. Furthermore, to guarantee the chaotic equation parameters and the current state values are always consistent, the parameters ROM reading submodule 102 and the chaotic state value RAM reading and writing submodule 103 share the same read address read_addr. When the resetting of the chaos iterative model module 1 ends, namely, res_n=1, and the input of the chaotic equation submodule 101 is valid at next clock, namely n_valid=1, the read address read_addr is set to 0, then increases 1 at each clock to guarantee the chaotic equation submodule 101 can obtain a pair of reading the chaotic equation parameters and the current state values at every clock. Each 245 clock is a complete cycle, namely, after the read address read_addr increases to 244, it will return to 0 at next clock and increase 1 at each clock, restarting a next cycle, namely next round calculation of next state values. The control timing diagram of read address read_addr is shown in FIG. 6.

At clock 2, reset signal res_n turns to high level, the reset the chaos iterative model module, the resetting of the chaos iterative model module 1 ends.

Then at clock 3, the input of the chaotic equation submodule 101 is valid, namely n_valid=1, the read address read_addr is set to 0, the chaotic equation parameters of pair 0 are read out from the parameters ROM reading submodule 102 at address 0, and the current state values of pair 0 are read out from the chaotic state value RAM reading and writing submodule 103 at address 0, the read out chaotic equation parameters and the current state values are sent to the chaotic equation submodule 101 to perform an iterative calculation.

At clock 4, read address read_addr=1, the chaotic equation parameters and the current state values of pair 1 are read out to perform an iterative calculation.

After 244 clocks, namely at clock 247, the first iterative calculation based on the chaotic equation parameters and the current state values of pair 0 are completed, starting to output the next state values. Meanwhile, the chaotic equation parameters and the current state values of pair 244 are read out and sent to the chaotic equation submodule 101.

At clock 248, read address read_addr_is set to 0 again, at this time, the inputs of the chaotic equation submodule 101 are the chaotic equation parameters of pair 0 and the next state values of the first iterative calculation. Meanwhile, the first iterative calculation based on the chaotic equation parameters and the current state values of pair 1 are completed, starting to output the next state values.

At clock 249, read address read_addr=1, at this time, the inputs of the chaotic equation submodule 101 are the chaotic equation parameters of pair 1 and the next state values of the first iterative calculation. Meanwhile, the first iterative calculation based on the chaotic equation parameters and the current state values of pair 2 are completed, starting to output the next state values.

And so on, thus the loop iterative calculation is realized.

To make the loop iterative calculation perform correctly, the input order of the chaotic equation submodule 101 must be guaranteed, in addition, the current state values stored in the chaotic state value RAM reading and writing submodule 103 must be updated correctly, namely guaranteeing that RAM write address write_addr in the chaotic state value RAM reading and writing submodule 103 changes correctly, which makes the used current state values precisely overwritten by the corresponding next state value obtained by each iterative calculation, thus the new calculated next state value can be taken as the current state values of next iterative calculation.

In the embodiment, the control timing diagram of write address write_addr is shown in FIG. 7.

At clock 3, the input of the chaotic equation submodule 101 is valid, namely input valid signal n_valid=1, the read address read_addr is set to 0, the chaotic equation parameters of pair 0 are read out from the parameters ROM reading submodule 102 at address 0, and the current state values of pair 0 are read out from the chaotic state value RAM reading and writing submodule 103 at address 0, the read out chaotic equation parameters and the current state values are sent to the chaotic equation submodule 101 to perform an iterative calculation. Thereafter the read address read_addr starts to increase cyclically, performing iterative calculation by continuously read out the chaotic equation parameters and the current state values.

After 244 clocks, namely at clock 247, the first iterative calculation based on the chaotic equation parameters and the current state values of pair 0 are completed. the output of the chaos iterative model module 1 is valid, namely output valid signal n_valid=1, at this time, the write address write_addr=0, which means the next current state values outputted by the chaotic equation submodule 101 at current time will be taken as the current state values of next iterative calculation to be stored in the space of the chaotic state value RAM reading and writing submodule 103 at write address 0, precisely overwriting the current state values (for the first iterative calculation, the current state values are the initial values from an upper computer) at write address 0. Thereafter the write address write_addr starts to increase cyclically.

At clock 248, the read address read_addr_is set to 0 again. The chaotic equation parameters of pair 0 are read out from the parameters ROM reading submodule 102 at address 0, and the current state values of pair 0 are read out from the chaotic state value RAM reading and writing submodule 103 at address 0, the read out chaotic equation parameters and the current state values are sent to the chaotic equation submodule 101 to perform the next iterative calculation. Meanwhile, the write address write_addr=1, the first iterative calculation based on the chaotic equation parameters and the current state values of pair 1 are completed, the next current state values outputted by the chaotic equation submodule 101 at current time will be taken as the current state values of next iterative calculation to be stored in the space of the chaotic state value RAM reading and writing submodule 103 at write address 1.

At clock 249, the read address read_addr=1, the write address write_addr=2, The chaotic equation parameters of pair 1 are read out from the parameters ROM reading submodule 102 at address 1, and the current state values of pair 1 are read out from the chaotic state value RAM reading and writing submodule 103 at address 1, the read out chaotic equation parameters and the current state values are sent to the chaotic equation submodule 101 to perform the next iterative calculation. the next current state values outputted by the chaotic equation submodule 101 at current time will be taken as the current state values of next iterative calculation to be stored in the space of the chaotic state value RAM reading and writing submodule 103 at write address 2, and so on.

Through the above method, the pipelining iterative calculation of the chaos iterative model module are realized, a plurality of next state values can be outputted at every clock, which dramatically enhances the calculation efficiency and the utilization of hardware computing units of a FPGA.

2. M-Sequence Update Control Module

The m-sequence update control module 2 is used for receiving the next state values and the write address outputted by the chaotic equation submodule and performing two operations: data combining: combining the next state values outputted by the chaotic equation submodule 1 into a data, namely combined data and outputting the combined data, and sequence module selectively updating: taking the write address as a chaos number to drive a m-sequence update state machine to output an update enable signal.

In the embodiment, the chaotic equation submodule 1 continuously calculates and outputs the next state values xₙ₊₁, yₙ₊₁ and zₙ₊₁ and the write address write_addr to the m-sequence update control module 2. The write address write_addr is taken as the identification signal of the next state values xₙ₊₁, yₙ₊₁ and zₙ₊₁, used for determining which pair of chaotic equation parameters and current state values the current next state values xₙ₊₁, yₙ₊₁ and zₙ₊₁ and taken as a chaos number (state update control signal) to drive a m-sequence update state machine to output an update enable signal update_valid.

In the embodiment, the m-sequence update control module 2 has two implementations.

2.1 Implementation 1

The combined data is sent simultaneously to each of the plurality of m-sequence modules 3, and according to the write address write_addr, the m-sequence update state machine continuously outputs the update enable signal update_valid, which enables m-sequence modules one by one.

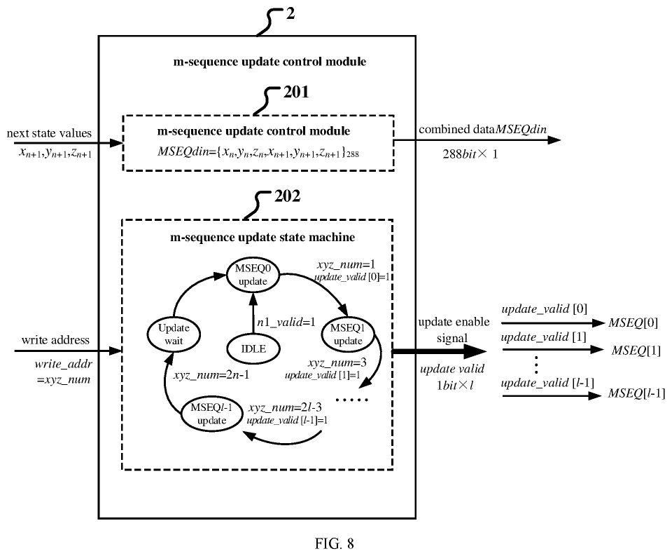

In the embodiment, as shown in FIG. 8, the m-sequence update control module 2 comprises a xyz data combination submodule 201 and a m-sequence update state machine 202. The xyz data combination submodule 201 combines the next state values outputted by the chaotic equation submodule into a data, namely combined data. In the embodiment, the next state values xₙ₊₁, yₙ₊₁ and zₙ₊₁ outputted by the chaotic equation submodule at two consecutive clocks are cut and combined into a 288-bit data, namely combined data MSEQ_din, which are outputted into the plurality of m-sequence modules 3, all m-sequence modules receive the combined data MSEQ_din. The update enable signal update_valid outputted by the m-sequence update state machine 202 is a multichannel signal of 1 bit×l, which can be expressed as update_valid[i], i=0,1, . . . , 1-1, a channel's signal update_valid[i] is connected to a m-sequence module MSEQ[i], i=0,1, . . . , 1-1,1 is the number of the plurality of m-sequence modules 3. In the embodiment, 1=16, namely, the plurality of m-sequence modules 3 comprised 16 m-sequence modules. In the embodiment, the i^{th} channel's signal update_valid[i] is connected to the i^{th} m-sequence module MSEQ[i]. When the i^{th} channel's signal update_valid[i] is high level, namely valid, it enables the i^{th} m-sequence module MSEQ[i].

The m-sequence update state machine 202 performs state transitions under the drive of the chaos number xyz_num, namely the write address write_addr, meanwhile, select one channel's signal update_valid[i] is high level, namely valid. In the embodiment, when the output of the chaos iterative model module 1 is valid, namely output valid signal n_valid=1, the state UPDATE STATE of the m-sequence update state machine 202 is transferred from state IDLE to state MSEQ0_update (abbreviated as M0_update). When the chaos number xyz_num=1, the xyz data combination submodule 201 cuts and combines the next state values xₙ, yₙ, zₙ, xₙ₊₁, yₙ₊₁, zₙ₊₁, which are calculated according to the chaotic equation parameters and the current state values of pair 0 and pair 1 into a 288-bit data, namely combined data MSEQ_din. At this time, only the 0^{th} channel's signal update_valid[0] are let valid, namely high level with one clock, which denotes that the current combined data MSEQ_din is used to update the m-sequence module MSEQ[0]. And then, the state UPDATE STATE is transferred to MSEQ1_update (abbreviated as M1 update), preparing to update the m-sequence module MSEQ[1]. When the chaos number xyz_num=3, only the lth channel's signal update_valid[1] are let valid, namely high level with one clock, the xyz data combination submodule 201 cuts and combines the next state values xₙ, yₙ, zₙ, xₙ₊₁, yₙ₊₁, zₙ₊₁, which are calculated according to the chaotic equation parameters and the current state values of pair 2 and pair 3 into a 288-bit data, namely combined data MSEQ_din, and the current combined data MSEQ_din is used to update the m-sequence module MSEQ[1]. And so on, until all m-sequence modules are updated, the state UPDATE STATE is transferred to state Update_wait. When the chaos number xyz_num=244, the state UPDATE STATE is transferred from state Update_wait to state MSEQ0_update, starting the next round of state transitions. The detailed control timing diagram of the m-sequence update control module is shown in FIG. 9.

In the present invention, the m-sequence modules need to read out corresponding m-sequence feedback coefficients from the m-sequence feedback coefficient ROM for building a new m-sequence feedback structure. When implement 1 is adopted to update the plurality of m-sequence modules 3, for the reason that each m-sequence module is updated at different clock, so the m-sequence feedback coefficient ROM can be removed from the corresponding m-sequence module, all m-sequence modules share the same plurality of store feedback coefficients which stored in a ROM. When the i^{th} channel's signal update_valid[i] is valid, the i^{th} m-sequence module MSEQ[1] accesses the ROM in which the same plurality of store feedback coefficients are stored, and reads out a feedback coefficient to the i^{th} m-sequence module MSEQ[1], thus a time division multiplexing is realized, which dramatically same the hardware resource of a FPGA.

2.1 Implementation 2

The m-sequence update control module 2 continuously combines the next state values outputted by the chaotic equation submodule 1 into a data, namely combined data, and stores the combined data, when number of the combined data is greater than the number of the plurality of m-sequence modules 3, all stored combined data are read out and outputted to corresponding m-sequence modules respectively, meanwhile, the m-sequence update control module outputs an update enable signal to all m-sequence modules to make them valid and read out their respective combined data.

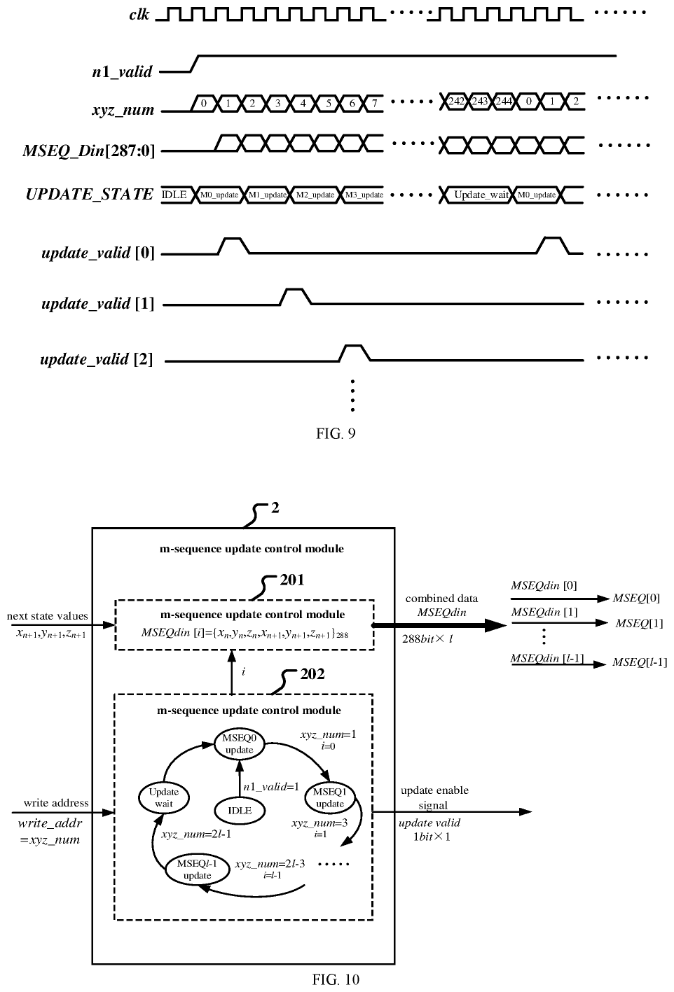

In the embodiment, as shown in FIG. 10, when the output of the chaos iterative model module 1 is valid, namely output valid signal n_valid=1, the state UPDATE STATE of the m-sequence update state machine 202 is transferred from state IDLE to state MSEQ0_update (abbreviated as M0_update). When the chaos number xyz_num=1, the xyz data combination submodule 201 cuts and combines the next state values xₙ, yₙ, zₙ, xₙ₊₁, yₙ₊₁, zₙ₊₁, which are calculated according to the chaotic equation parameters and the current state values of pair 0 and pair 1 into a 288-bit data, namely combined data MSEQ_din[0], then the combined data MSEQ_din[0] is stored, the state UPDATE STATE is transferred to MSEQ1_update (abbreviated as M1 update). When the chaos number xyz_num=3, the xyz data combination submodule 201 cuts and combines the next state values xₙ, yₙ, zₙ, xₙ₊₁, yₙ₊₁, zₙ₊₁, which are calculated according to the chaotic equation parameters and the current state values of pair 2 and pair 3 into a 288-bit data, namely combined data MSEQ_din[1], then the combined data MSEQ_din[1] is stored, the state UPDATE STATE is transferred to MSEQ2_update (abbreviated as M2_update), and so on, until l combined data MSEQ_din[1], i=0,1, . . . , l-1 are obtained, the state UPDATE STATE is transferred to Update_wait. When the chaos number xyz_num=244, the state UPDATE STATE is transferred from state Update_wait to state MSEQ0_update, l combined data MSEQ_din[i], 1=0,1, . . . , 1-1 are simultaneously outputted to their respective m-sequence modules MSEQ[1], 1=0,1, . . . , 1-1, meanwhile, the update enable signal update_valid is let valid, which make all m-sequence modules MSEQ[1], 1=0,1, . . . , l-1 valid, reading their respective combined data MSEQ_din[1], 1=0,1, . . . , l-1, then the state UPDATE STATE is transferred to state MSEQ0_update, starting the next round of state transitions. The detailed control timing diagram of the m-sequence update control module is shown in FIG. 11.

3. A Plurality of m-Sequence Modules

Each m-sequence module of the plurality of m-sequence modules 3 comprises multiple pairs of m-sequence generator and m-sequence feedback coefficient ROM, when a m-sequence module receives the combined data and the update enable signal, it splits the combined data into multiple pairs of m-sequence generator initial value and feedback coefficient read address, each pair of m-sequence generator initial value and feedback coefficient read address corresponds to a pair of m-sequence generator and m-sequence feedback coefficient ROM, the m-sequence module reads out a m-sequence feedback coefficient according its feedback coefficient read address, and then updates the feedback coefficient of the m-sequence generator with the m-sequence feedback coefficient and the initial value of the m-sequence generator with the m-sequence generator initial value; a m-sequence generator outputs one-bit data at every clock, the one-bit data outputted by the m-sequence generators of a m-sequence module at every clock compose one multi-bit data of a channel, the multi-bit data outputted by the plurality of m-sequence modules compose a plurality of ultra-high speed multi-bit pseudo-random signals.

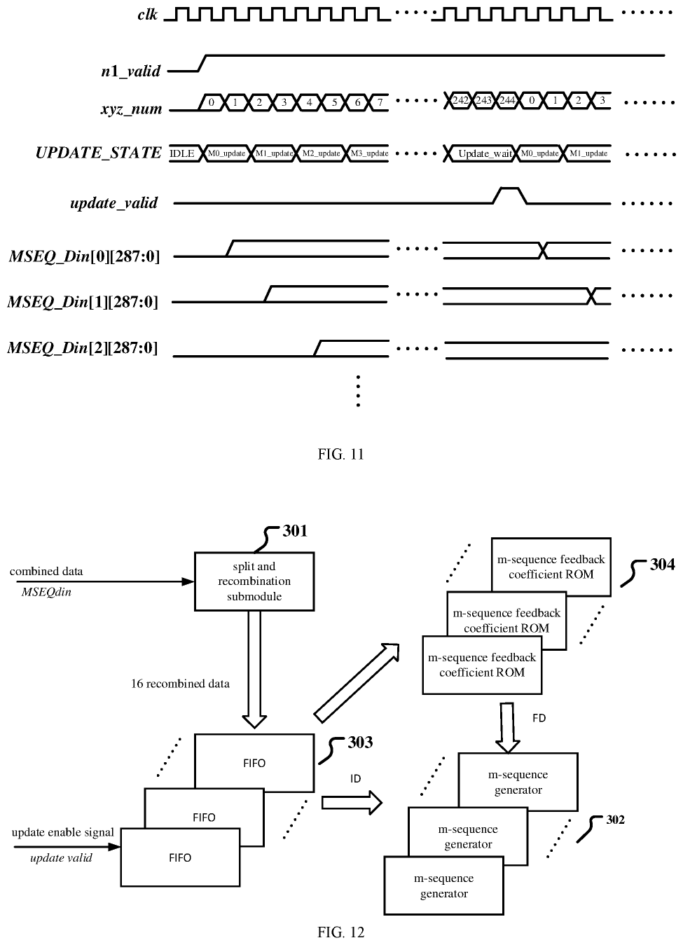

In the embodiment, as shown in FIG. 12, Each m-sequence module comprises a split and recombination submodule 301, 16 m-sequence generator 302, 16 FIFO memory 303 and 16 m-sequence feedback coefficient ROM 304. After receiving a 288-bit combined data, split and recombination submodule 301 splits the combined data into 16 recombined data, each recombined data comprises 16-bit m-sequence generator initial value ID and 11-bit feedback coefficient read address Cread_addr and corresponds a m-sequence module. When the update enable signal update_valid (which is connected to the corresponding channel's signal update_valid[i] outputted by the m-sequence update control module 2 in implementation 1, the update enable signal update_valid outputted by the m-sequence update control module 2 in implementation 2) of a m-sequence module is valid, the 16 recombined data are stored into the 16 FIFO memory 303 respectively.

For a m-sequence generator, according to corresponding 11-bit feedback coefficient read address Cread_addr stored in corresponding FIFO memory, it read out a 16-bit m-sequence feedback coefficient FD from the corresponding m-sequence feedback coefficient ROM, which is used to update the m-sequence generator with corresponding 16-bit m-sequence generator initial value ID stored in corresponding FIFO memory. 16 pairs of 16-bit m-sequence feedback coefficient FD and m-sequence generator initial value ID are sent to the 16 m-sequence generator 302 respectively, completing the construction and update of the 16 m-sequence generator 302. Finally, a m-sequence generator outputs one-bit data at every clock, the one-bit data outputted by the m-sequence generators of a m-sequence module at every clock compose one 16-bit data of a channel.

For 16 m-sequence modules, as shown in FIG. 1, the 16-bit data outputted by 16 m-sequence modules compose 16 channels of ultra-high speed 16-bit pseudo-random signals PRN_CH0-PRN_CH15.

In the present invention, the next state values outputted by the chaotic equation submodule are taken as the m-sequence generator initial values and the feedback coefficient read addresses of m-sequence modules, and the number of the next state values outputted by the chaotic equation submodule in unit time is limited. To guarantee that all m-sequence modules are updated in real time before falling into output repetition and avoid cycle recurring of multi-bit data of a channel, the number Q of m-sequence modules is also limited. Supposing the next state values outputted by a m-sequence module at every clock are p-bit data and each m-sequence module comprises Q₁ n-bit m-sequence generators (The cycle of each m-sequence generator is T=2ⁿ−1), nQ₁ bits of the next state values are needed to update the m-sequence generator initial values and the feedback coefficient read addresses of a m-sequence module. In the cycle of each m-sequence generator, only TP bits of next state values are available, so the maximum number Q of m-sequence modules is:

$$Q = \frac{TP}{{nQ}_{1}}$$

In the embodiment, the chaotic equation submodule comprises x, y and z dimensions, each dimension uses 64-bit number to calculate its next state value, so P=64×3=192. A m-sequence module comprises 16 16-bit m-sequence generators, namely n=16, Q₁=16, then the maximum number Q of m-sequence modules is:

$$Q = \frac{TP}{{nQ}_{1}} = \frac{( {2}^{16} - 1 ) \times 192}{16 \times 16} = 49151$$

Supposing system clock f_{sys}=100 Mhz, the throughput ratio of generating pseudo-random signals is: Q×Q₁×f_{sys}=49151×16×100 Mbps=78.6 Tbps.

4. DDS Module

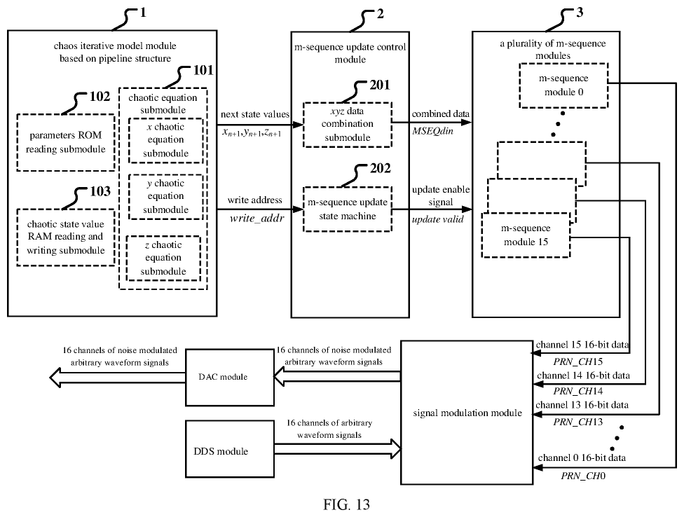

FIG. 13 is a diagram of a multichannel pseudo-random noise modulation device in accordance with one embodiment of the present invention.

In the embodiment, as shown in FIG. 13, the present invention provides a multichannel pseudo-random noise modulation device, which comprises a chaos iterative model module based on pipeline structure 1, a m-sequence update control module 2, a plurality of m-sequence modules 3, a DDS module 4, a signal modulation module 5 and a DAC module 6.

The DDS module 4 is used for generating a plurality of arbitrary waveform signals, wherein an arbitrary waveform signal corresponds to an ultra-high speed multi-bit pseudo-random signal. The DDS module 4 can generate various arbitrary waveform signals, such as sinusoidal wave, square wave, triangular wave and third harmonic wave. In the embodiment, The DDS module 4 is used for generating 16 channels of arbitrary waveform signals, which are outputted to the signal modulation module 5. The shapes, frequencies and phases of the arbitrary waveform signals are controlled by an upper computer. The theory of generating arbitrary waveform signals belongs to the prior art, the details are not elaborated herein.

5. Signal Modulation Module

The signal modulation module 5 is used for receiving the plurality of ultra-high speed multi-bit pseudo-random signals and the plurality of arbitrary waveform signals, and taking each ultra-high speed multi-bit pseudo-random signal as a noise signal to modulate its corresponding arbitrary waveform signal by additive modulation ratio k, then converting the format of the modulated arbitrary waveform signals into 14-bit integer and outputting the modulated arbitrary waveform signal of 14-bit integer to the DAC module 6, where additive modulation ratio k is sent from an upper computer. In the embodiment, 16 channels of modulated arbitrary waveform signals are outputted to the DAC module 6.

6. DAC Module

The DAC module 6 is used for converting each modulated arbitrary waveform signal of integer outputted by the signal modulation module 5 into an analog signal, wherein all analog signals compose multi channels of pseudo-random noise signals.

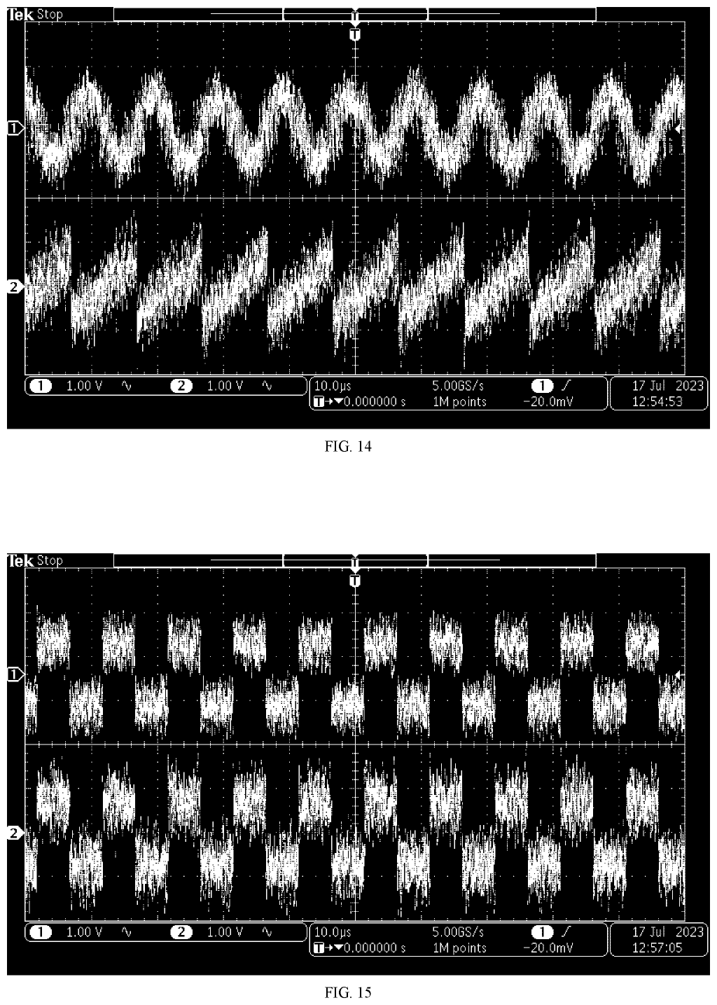

FIG. 14 shows the illustrations of modulating different waveform signals, where the arbitrary waveform signal of channel 1 is a sinusoidal wave, the arbitrary waveform signal of channel 2 is a triangular wave. FIG. 15 shows illustrations of modulating a square waveform signal by different additive modulation ratios, where channel 1 shows the case of additive modulation ratio k=0.4, channel 2 shows the case of additive modulation ratio k=0.5. From the FIG. 14 and FIG. 15 (In the figures, only the waveforms of channel 1 and channel 2 are illustrated), we can see that the present invention can realize the uniform modulation of arbitrary waveform signals of multiple channels with ultra-high pseudo-random noises.

While illustrative embodiments of the invention have been described above, it is, of course, understand that various modifications will be apparent to those of ordinary skill in the art. Such modifications are within the spirit and scope of the invention, which is limited and defined only by the appended claims.

What is claimed is:

1. An apparatus for generating a plurality of ultra-high speed pseudo-random signals, comprising:
a chaos iterative model module based on pipeline structure, which consists of a chaotic equation submodule, a parameters ROM reading submodule and a chaotic state value RAM reading and writing submodule, wherein when a time delay is needed for synchronization in each chaotic equation and between chaotic equations of the chaotic equation submodule, a shift register is adopted to buffer the early result through its shift, the number of the registers in the shift register is equal to the number of the clocks that correspond to the time delay, which makes the chaotic equation submodule can perform iterative calculation with pipelining, the parameters ROM reading submodule is used for storing m pluralities of chaotic equation parameters, the chaotic state value RAM reading and writing submodule is used for storing m pluralities of current state values, the initial values of m pluralities of current state values are from an upper computer; for each clock, a plurality of chaotic equation parameters are read out from the parameters ROM reading submodule and sent to the chaotic equation submodule, a plurality of current state values are read out from the chaotic state value RAM reading and writing submodule and sent to the chaotic equation submodule, the chaotic equation submodule performs iterative calculation by received plurality of chaotic equation parameters and plurality of current state values, and then, on the one hand, the results of the iterative calculation, namely next state values are outputted, on the other hand, taken as the current state values of next iterative calculation to update the current state values in the chaotic state value RAM reading and writing submodule, meanwhile, the chaotic equation submodule outputs a write address which is used for updating the current state values in the chaotic state value RAM reading and writing submodule, where m is greater than the number of the clocks needed in calculation of a plurality of next state values;
a m-sequence update control module, which is used for receiving the next state values and the write address outputted by the chaotic equation submodule and performing two operations: data combining: combining the next state values outputted by the chaotic equation submodule into a data, namely combined data and outputting the combined data, and sequence module selectively updating: taking the write address as a chaos number to drive a m-sequence update state machine to output an update enable signal;
a plurality of m-sequence modules, where each m-sequence module comprises multiple pairs of m-sequence generator and m-sequence feedback coefficient ROM, when a m-sequence module receives the combined data and the update enable signal, it splits the combined data into multiple pairs of m-sequence generator initial value and feedback coefficient read address, each pair of m-sequence generator initial value and feedback coefficient read address corresponds to a pair of m-sequence generator and m-sequence feedback coefficient ROM, the m-sequence module reads out a m-sequence feedback coefficient according its feedback coefficient read address, and then updates the feedback coefficient of the m-sequence generator with the m-sequence feedback coefficient and the initial value of the m-sequence generator with the m-sequence generator initial value; a m-sequence generator outputs one-bit data at every clock, the one-bit data outputted by the m-sequence generators of a m-sequence module at every clock compose one multi-bit data of a channel, the multi-bit data outputted by the plurality of m-sequence modules compose a plurality of ultra-high speed multi-bit pseudo-random signals.

2. An apparatus for generating a plurality of ultra-high speed pseudo-random signals of claim 1, wherein the combined data is sent simultaneously to each of the plurality of m-sequence modules, and according to the write address, the m-sequence update state machine continuously outputs the update enable signal, which enables m-sequence modules one by one.

3. An apparatus for generating a plurality of ultra-high speed pseudo-random signals of claim 1, wherein the m-sequence update control module continuously combines the next state values outputted by the chaotic equation submodule into a data, namely combined data, and stores the combined data, when number of the combined data is greater than the number of the plurality of m-sequence modules, all stored combined data are read out and outputted to corresponding m-sequence modules respectively, meanwhile, the m-sequence update control module outputs an update enable signal to all m-sequence modules to make them valid and read out their respective combined data.

4. A multichannel pseudo-random noise modulation device, comprising:
a chaos iterative model module based on pipeline structure, which consists of a chaotic equation submodule, a parameters ROM reading submodule and a chaotic state value RAM reading and writing submodule, wherein when a time delay is needed for synchronization in each chaotic equation and between chaotic equations of the chaotic equation submodule, a shift register is adopted to buffer the early result through its shift, the number of the registers in the shift register is equal to the number of the clocks that correspond to the time delay, which makes the chaotic equation submodule can perform iterative calculation with pipelining, the parameters ROM reading submodule is used for storing m pluralities of chaotic equation parameters, the chaotic state value RAM reading and writing submodule is used for storing m pluralities of current state values, the initial values of m pluralities of current state values are from an upper computer; for each clock, a plurality of chaotic equation parameters are read out from the parameters ROM reading submodule and sent to the chaotic equation submodule, a plurality of current state values are read out from the chaotic state value RAM reading and writing submodule and sent to the chaotic equation submodule, the chaotic equation submodule performs iterative calculation by received plurality of chaotic equation parameters and plurality of current state values, and then, on the one hand, the results of the iterative calculation, namely next state values are outputted, on the other hand, taken as the current state values of next iterative calculation to update the current state values in the chaotic state value RAM reading and writing submodule, meanwhile, the chaotic equation submodule outputs a write address which is used for updating the current state values in the chaotic state value RAM reading and writing submodule, where m is greater than the number of the clocks needed in calculation of a plurality of next state values;
a m-sequence update control module, which is used for receiving the next state values and the write address outputted by the chaotic equation submodule and performing two operations: data combining: combining the next state values outputted by the chaotic equation submodule into a data, namely combined data and outputting the combined data, and sequence module selectively updating: taking the write address as a chaos number to drive a m-sequence update state machine to output an update enable signal;
a plurality of m-sequence modules, where each m-sequence module comprises multiple pairs of m-sequence generator and m-sequence feedback coefficient ROM, when a m-sequence module receives the combined data and the update enable signal, it splits the combined data into multiple pairs of m-sequence generator initial value and feedback coefficient read address, each pair of m-sequence generator initial value and feedback coefficient read address corresponds to a pair of m-sequence generator and m-sequence feedback coefficient ROM, the m-sequence module reads out a m-sequence feedback coefficient according its feedback coefficient read address, and then updates the feedback coefficient of the m-sequence generator with the m-sequence feedback coefficient and the initial value of the m-sequence generator with the m-sequence generator initial value; a m-sequence generator outputs one-bit data at every clock, the one-bit data outputted by the m-sequence generators of a m-sequence module at every clock compose one multi-bit data of a channel, the multi-bit data outputted by the plurality of m-sequence modules compose a plurality of ultra-high speed multi-bit pseudo-random signals;
a DDS module, which is used for generating a plurality of arbitrary waveform signals, wherein an arbitrary waveform signal corresponds to an ultra-high speed multi-bit pseudo-random signal;
a signal modulation module, which is used for receiving the plurality of ultra-high speed multi-bit pseudo-random signals and the plurality of arbitrary waveform signals, and taking each ultra-high speed multi-bit pseudo-random signal as a noise signal to modulate its corresponding arbitrary waveform signal by additive modulation ratio k, then converting the format of the noise modulated arbitrary waveform signals into integer and outputting the modulated arbitrary waveform signals of integer, where additive modulation ratio k is sent from an upper computer;
a DAC module, which is used for converting each noise modulated arbitrary waveform signal of integer outputted by the signal modulation module into an analog signal, wherein all analog signals compose multi channels of pseudo-random noise signals.
